(19) United States
(12) Patent Application Publication
(10) Pub. No.: US 2020/0229362 A1
(43) Pub. Date: Jul. 23, 2020

(54) Recirculating Aeroponics System for Plant Growing

(71) Applicant: Kelly Scott, Wadsworth, NV (US)

(72) Inventor: Kelly Scott, Wadsworth, NV (US)

(21) Appl. No.: 16/715,428

(22) Filed: Dec. 16, 2019

Related U.S. Application Data
(60) Provisional application No. 62/780,849, filed on Dec. 17, 2018.

(51) Int. Cl. A01G 31/02

(52) U.S. Cl. CPC A01G 31/02

(57) ABSTRACT

An aeroponic system uses a first container operating as a nutrient reservoir container, and a second container, separate from the nutrient reservoir container, operating as a grow container. A spray and recirculating assembly, fitting inside the second container, having a first upper section with plural sprayers thereon, the plural sprayers extending toward an inside of the grow basket, into an area where the grow basket will reside inside the grow container. A Venturi device draws excess solution from the bottom of the grow container through the draw up hose, and provides the excess solution, after being aerated by the Venturi valve back to the nutrient reservoir.

This application claims priority from Provisional application No. 62/780,849, filed Dec. 17, 2019, the entire contents of which are herewith incorporated by reference.

### BACKGROUND

Aeroponics systems grow plants in the air and mist environment without the use of soil or aggregate. The roots grow directly into a space inside a container, and that area is misted by a nutrient solution.

Aeroponics systems have many advantages, including improved oxygen in the root zone, and better ability to prevent insects and parasites.

A conventional Aeroponics system recirculates liquid in a container across a root zone of a plant.

### SUMMARY

The inventor recognizes advantages from a low pressure aeroponics system where the solution is maintained in a first nutrient holding container, and circulated into a second plant containing container in a way that maximizes aeration using a Venturi valve.

### BRIEF DESCRIPTION OF THE DRAWINGS

The different figures show different embodiments.

FIG. 1 shows a basic layout showing nutrient reservoir implant reservoir connected together by hoses;

FIG. 2 shows an inside of the plant bucket showing the sprayers and the return plumbing;

FIG. 3 shows an inside of the nutrient bucket;

FIG. 4 shows the structure that goes inside the plant bucket;

FIG. 5 shows the standoffs.

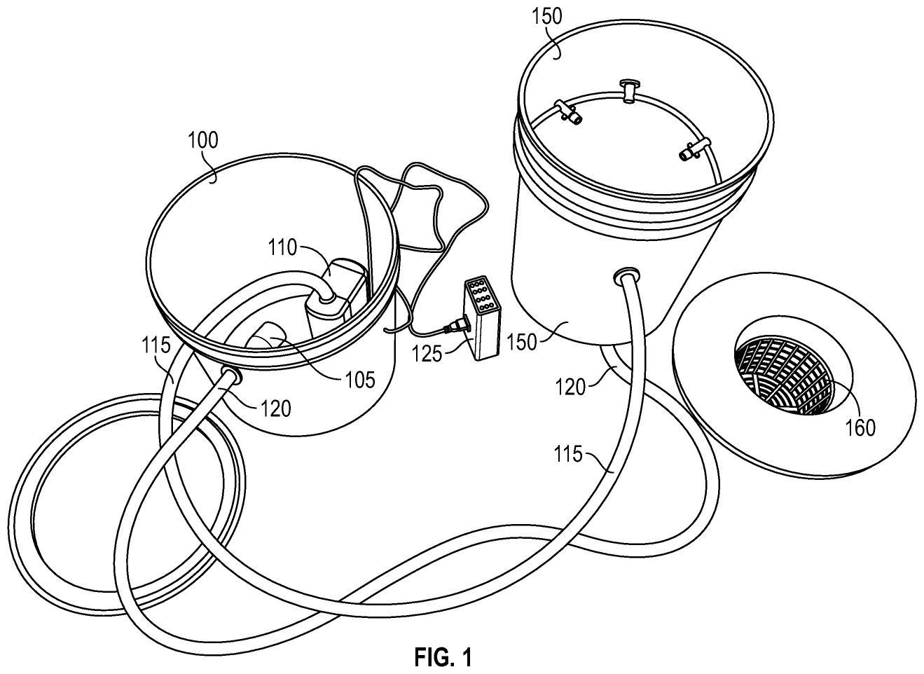

### DETAILED DESCRIPTION

An embodiment shown in the figures. A first nutrient holding container, e.g., a bucket 100, holds the solution that will be circulated to the plants that are held in the second plant holding container, e.g., bucket 150. The solution is inside the inside 105 of the bucket 100. A pump 110 pumps the solution through a hose 115 that extends through the side of the bucket 100, and into the side of the plant holding bucket 150. The tube 115 extends through the wall 151 of the bucket 150 at a location approximately halfway or more up the bucket.

In one embodiment, the location where the tube extends through the bucket is sealed against leakage, e.g., by a grommet, or by using a tight fit, or by a gasket or sealant.

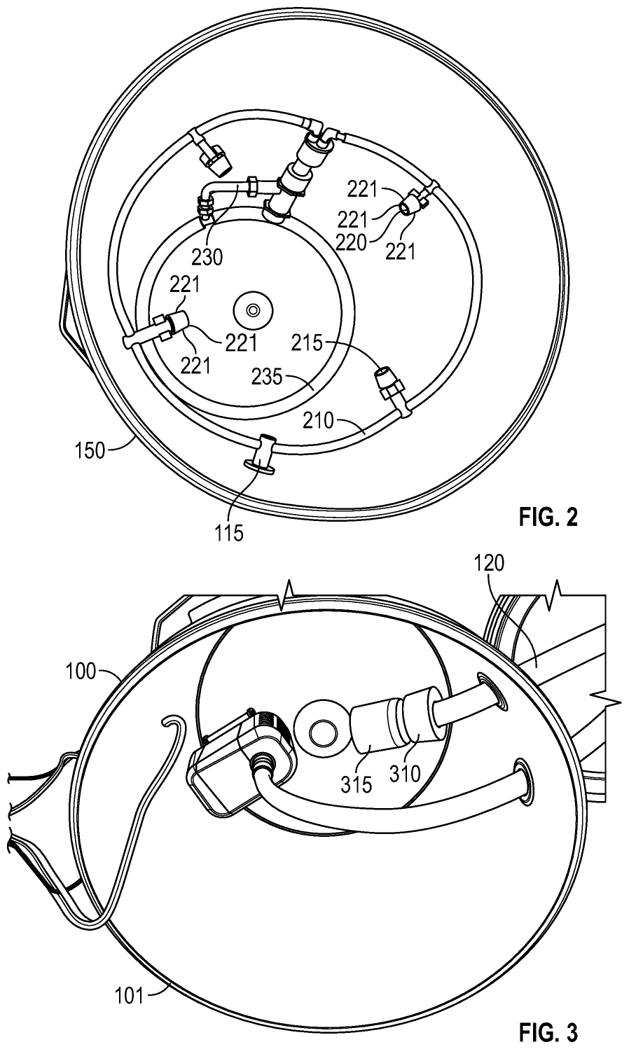

FIG. 2 shows an inside view of the bucket 150, with the supply hose 115 extending into the bucket. The hose has a small gauge (e.g. 16 gauge) wire (e.g., a stainless steel wire) inside it to make the flexible hose 210 stay where you set it, so it can stay in place. In this embodiment, the bucket is shown as a cylindrical bucket, and hence the flexible hose 210 forms an area that covers parts of that perimeter. In other embodiments, the bucket can be square or rectangular, in which case the hose could be of a similar shape to the bucket. The wire inside the hose can be used to The hose assembly 210 includes a plurality of sprayers 215, 220. These spray a nutrient mist, shown generically as 221, into the central area of the growing bucket 150. As conventional, a plant holding mesh basket 160 is placed into the bucket in a way that places the roots of the plant in the area of the mist 221.

The liquid is pumped by the pump 110 through the tube 115, and after the mist comes into contact with the roots, the excess nutrient liquid falls down by gravity into the bottom of the growing bucket 150.

The hose assembly includes a Venturi device which draws up the excess sprayed nutrients and recirculates those nutrients through another tube back to the nutrient reservoir 100. The Venturi valve is attached to a perimeter draw up hose 235 which in this embodiment can be formed from a modified soaker hose which allows liquid to pass through, but filters solids from passing through. The hose is formed of rubber or other elastomeric material having small holes through the rubber at regular or irregular intervals that allows liquid seepage through the rubber.

The nutrient reservoir shown in further detail in FIG. 3, showing the tube 120 entering the nutrient reservoir, passing through the wall 101 of the nutrient reservoir 100, and where the end of the tube 310 is covered with a filter material 315 to prevent solids from passing into the reservoir.

The pump 110 is an electrical pump driven by a timer device 125 which can run for example one minute per hour. During the times between the running, the roots stay wet by virtue of the closed system.

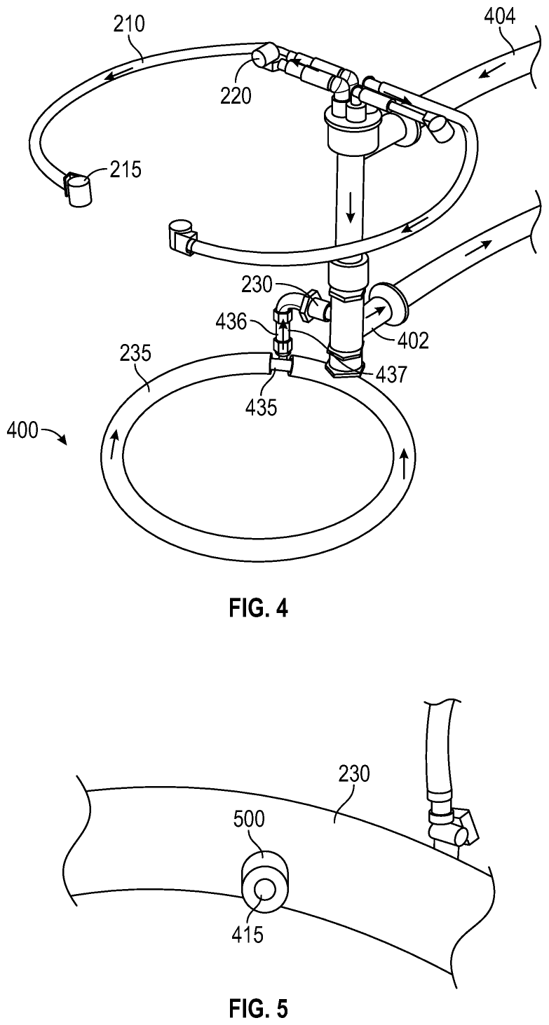

FIG. 4 shows additional detail of the sprayer and recirculating assembly 400 that is located in the grow reservoir, showing the different parts referred to above. As shown in FIG. 4, the draw up hose 235 includes a right angle connection 435 which connects to the draw up hose 235 and extends upwardly, so that the fluid received through the draw up hose reaches a level. A check valve 436 prevents the water from being forced through the draw up hose, and only allows the water to travel in the direction of the arrow 437, to prevent back flow. The fluid at that level is then coupled back to the Venturi valve 230 which aerates the water using the low pressure venturi effect.

The check valve is placed between the bottom draw up hose and the venturi, to make the system completely able to withstand improper connections.

The water from the other reservoir is pumped in to connection 404, and sprayed by sprayers 215, 220.

A number of advantages can be expected from the system. Modified soaker hoses attached to the suctioning side of the Venturi helps filter the solution and also prevents roots from growing into the Venturi valve.

By using a separate reservoir, the system becomes easier to drain and fill, and can be kept inside or outside of a hydroponic tent, for example. By keeping the nutrient reservoir outside the growing tent, this can allow easier control of the water temperature. This system uses less nutrients and water, and the nutrient solution stays cleaner between changing, and is easier to change. By running the pump only one minute per hour, less energy usage will be expected. However, even though less energy usage is expected, a maximum amount of oxygen is provided to the roots meaning healthier plants for maximum yield.

Since the spray and recirculating assembly 400 is an integral unit, it can be removed as one piece from the container for cleaning or for replacing the perimeter draw up hose 235 if it becomes clogged from excess debris.

In one embodiment, the spray and recirculating assembly 400 can use all separable parts. The hose connections 402, 404 can be quick connect connectors that connect to the different hoses enabling a fast disconnection of the spray and recirculating assembly 400 to remove it in order to replace any parts. Each of the sprayers, such as 406, can similarly be on quick disconnect couplings 408 to make it simple to remove the sprayer assembly 406 and replace it with another sprayer, if the sprayer assembly 406 becomes clogged. The entire sprayer assembly 406 is removed by unscrewing and then replaced.

For maximum efficiency of the draw up hose 235, the draw up hose may include a plurality of standoffs shown as 410, 420, spaced around the bottom of the perimeter draw up hose. In one embodiment, there may be 4 or 5 of the standoffs, but whatever number is necessary in order to attempt to maintain the draw up hose 235 off the bottom of the bucket. This spaces the bottom of the perimeter draw up hose off the bottom surface of the bucket so that the entirety of the perimeter draw up hose can function to draw up excess nutrient solution.

FIG. 5 illustrates a close-up of the standoff 415 seen from the bottom of the hose 230. The standoff is formed from a piece of porous material, for example a similar kind of material to that of the draw up hose, but the standoff can be of a smaller diameter than that of the draw up hose. A bore of that smaller diameter 500 is formed in the bottom of the soak up hose. This bore is formed only a part of the way through the soaker hose 230, and the standoff piece 415 is either press-fit or glued into the bore 500. In this way, the entire surface of the soaker hose can more easily receive the liquid to be returned to the nutrient reservoir. Both the top and the bottom of the soaker hose receive that nutrient, and also, the area of the standoff piece 415 can receive that nutrient, since the standoff itself 415 is also formed of a porous material.

Moreover, it is easy to check the pH and total dissolved solids as well as other characteristics of the nutrient solution, since the nutrient container holds only nutrient and does not have a plant or any roots in that container.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An aeroponic device plant growing system, comprising:
a first container operating as a nutrient reservoir container,
a second container, separate from the nutrient reservoir container, operating as a grow container, the grow container having surfaces for holding a grow basket inside an inner surface of the second container, the grow basket having surfaces for holding roots of a plant inside the grow basket;
a spray and recirculating assembly, fitting inside the second container, having a first upper section with plural sprayers thereon, the plural sprayers extending toward an inside of the grow basket, into an area where the grow basket will reside inside the grow container, and
the spray and recirculating assembly having a lower section, with a draw up hose extending adjacent a perimeter of the inner surface of the grow container, the draw up hose formed of a porous material which allows liquid to pass through, and which prevents at least some solids from passing through the draw up hose,
a Venturi device drawing excess solution from the grow container through the draw up hose, and connected to provide the excess solution, after being aerated by the Venturi valve, to an outlet, receiving the nutrient which has passed through the perimeter draw up hose and the Venturi device, back to the nutrient reservoir container,
the spray and recirculating assembly including an input for pressurized nutrient from the nutrient reservoir container, where the pressurized nutrient is fed to the plural sprayers, and including an outlet for expended nutrient, connected to the reservoir container, the outlet receiving nutrient from which has passed through the perimeter draw up hose.

2. The system as in claim 1, further comprising a first hose extending from the outlet to an inside of the reservoir container, and further comprising a filter, filtering the output of the first hose extending from the outlet to the inside of the first container to prevent solids from being from transferring to the inside of the first container.

3. The system as in claim 1, further comprising a pump in the reservoir container, and a second hose, extending from the pump in the reservoir container to the inlet of the grow container.

4. The system as in claim 2, further comprising a pump in the reservoir container, and a second hose, extending from the pump in the reservoir container to the inlet of the grow container.

5. The system as in claim 4, wherein the first and second hoses include quick connect connections thereon, and where the spray and recirculating assembly is completely removable from the plant growing reservoir after disconnecting the quick connect connections.

6. The system as in claim 1, further comprising a plant growing basket, having outer surfaces which fit to the inner surfaces of the grow container, and which form a closed system inside the grow container, the plant growing basket including a basket for holding the plant, the plant basket being perforated to allow liquid from the sprayers to reach roots of the plant, and a first solid section extending from a perimeter of the basket to the perimeter edge of the grow container, the solid section not being perforated.

7. The system as in claim 1, wherein the perimeter draw up hose includes standoffs on a bottom surface thereof, maintaining a bottom surface of the perimeter draw up hose spaced from a bottom surface of the growing container.

8. The system as in claim 7, wherein the standoffs are formed of a porous material.

9. The system as in claim 1, further comprising a check valve, preventing reverse pressure though the perimeter draw up hose.
